(19) United States
(12) Patent Application Publication
(10) Pub. No.: US 2007/0190409 A1
(43) Pub. Date: Aug. 16, 2007

(54) PACKAGING STRUCTURE OF ELECTRIC STORAGE CELLS

(75) Inventor: Masato Sakurai, Tokyo (JP)

Correspondence Address: DARBY & DARBY P.C., P.O. BOX 770, Church Street Station, New York, NY, 10008-0770, US

(73) Assignee: FUJI JUKOGYO KABUSHIKI KAISHA, Tokyo (JP)

(21) Appl. No.: 11/737,182

(22) Filed: Apr. 19, 2007

Related U.S. Application Data
(63) Continuation of application No. PCT/JP05/19508, filed on Oct. 24, 2005.

(30) Foreign Application Priority Data
Oct. 29, 2004 (JP) 2004-315350

(51) Int. Cl. H01M 2/10

(52) U.S. Cl. 429/159; 429/99

(57) ABSTRACT

Heat generated at electric storage cells are released using intermediate plates that are disposed at intervals of a predetermined number of layers in a lamination of the electric storage cells so as to retain the stacking surfaces of the electric storage cells therebetween, and at the same time, stacking surfaces of the cells are pressed with predetermined pressures by applying loads to the intermediate plates using wires provided for frame supports that are engaged with the intermediate plates. With this, the characteristics of the cells can be stabilized against both vibration and heat, and the performance of the entire package can be improved.

### CROSS REFERENCE TO RELATED APPLICATION

This application is a continuation of PCT Application No. PCT/JP2005/019508 filed on Oct. 24, 2005, which in turn claims the benefit of Japanese Application No. 2004-315350 filed Oct. 29, 2004. The International Application was published in Japanese as WO 2006/046515 on May 4, 2006. The priority applications identified above are incorporated herein by reference.

### BACKGROUND OF THE INVENTION

1. Field of the Invention

The present invention relates to packaging structures of electric storage cells including a plurality of flat electric storage cells that are stacked and packaged.

2. Description of the Related Art

Recently, flat electric storage cells such as lithium-ion secondary batteries and electric double-layer capacitors having substantially flat and rectangular shapes have been in practical use, and have been seen as promising power sources for various devices due to their high energy density, easiness of size reduction and maintenance, and the like.

Such flat electric storage cells are often used as assembled batteries in which a plurality of electric storage cells are stacked and packaged. In the case of electric storage cells used as power sources for hybrid electric vehicles, electric vehicles, or the like, characteristics of the cells including internal electrodes composed of active material paste applied on underlying metal foil as in lithium-ion batteries or the like can be degraded since the active material peels off the underlying metal foil due to vibration during use.

To solve this, Japanese Unexamined Patent Application Publication No. 2003-323874, for example, discloses a technology for preventing the exfoliation of an active material applied on electrodes of tabular batteries caused by vibration, by winding belts around the stacked tabular batteries so as to fasten the batteries together.

Although the technology disclosed in Japanese Unexamined Patent Application Publication No. 2003-323874 is effective in stabilizing battery performance against vibration, the effects of heat generated by electric storage cells in use are unconsidered. That is, when a plurality of electric storage cells are stacked, measures against the heat generated at the cells are essential as well as the measures against the degradation of battery performance caused by vibration. When no such measures are taken, the temperature of the entire package is excessively increased due to the stored heat of the stacked cells, and a decrease in electricity storage or degradation of power generation capacity may occur.

The present invention is produced with consideration of the above-described circumstances. It is an object of the present invention to provide a packaging structure of electric storage cells capable of stabilizing the characteristics of the electric storage cells by applying pressure to the stacking surfaces of electric storage cells, and at the same time, stabilizing the characteristics of the cells by effectively releasing heat generated at the electric storage cells.

### SUMMARY OF THE INVENTION

To achieve the above-described object, a packaging structure of electric storage cells according to the present invention includes, having a plurality of flat electric storage cells stacked and packaged, including tabular members that are in contact with stacking surfaces of the electric storage cells so as to retain the electric storage cells between the tabular members and to transfer and release heat generated at the electric storage cells; columnar members that form a framework for accommodating a lamination of the electric storage cells and are engaged with the tabular members such that the tabular members are movable in a stacking direction of the electric storage cells; and pressurizing members that are provided for the columnar members and apply a predetermined pressure to the stacking surfaces of the electric storage cells so as to retain the electric storage cells by applying a predetermined load to the tabular members, and in which sheet films for transferring heat generated at electric storage portions of the electric storage cells are disposed on the stacking surfaces of the electric storage cells in each layer so as to be stuck to the electric storage portions.

In this case, it is preferable that the tabular members are disposed at intervals of a predetermined number of layers in the lamination stacked the electric storage cells. Moreover, it is preferable that sheet films for transferring heat generated at electric storage portions of the electric storage cells are disposed on the stacking surfaces of the electric storage cells in each layer so as to be stuck to the electric storage portions.

Moreover, it is preferable that a heat-transferring member is provided for the tabular members so as to three-dimensionally transfer heat in the stacking direction of the electric storage cells, the heat being transferred from the electric storage cells to the tabular members, and that the heat-transferring member is a hollow pipe.

Moreover, the pressurizing members can be wires extending through the columnar members with a predetermined tension, or can be screws that engage the columnar members and the tabular members. In the case of using the wires, it is preferable that the packaging structure further includes a spacer including a curved-surface portion onto which the wires extending from the columnar members are wound and a pushing portion for uniformly pressing the tabular members using the tension of the wires wound onto the curved-surface portion.

Furthermore, it is preferable that the tabular members are composed of a composite of a carbon-based material and an aluminum-based material.

### BRIEF DESCRIPTION OF THE DRAWINGS

FIG. 1 is a general view of a power-supply unit including an electric storage package.

FIG. 2 is an explanatory diagram of showing the layout of frame supports and heat-transferring pipes.

FIG. 3 is an explanatory diagram of showing a front plate.

FIG. 4 is an explanatory diagram of showing a rear plate.

FIG. 5 is an explanatory diagram of showing a central cross section of the electric storage package in the longitudinal direction thereof.

FIG. 6 is an explanatory diagram of showing a state of electric storage cells stacked via intermediate plates.

FIG. 7 is an explanatory diagram of showing an example of connection between a heat-transferring sheet film and external heat-releasing members.

FIG. 8 is an explanatory diagram of showing a state of the electric storage cells to which tab supports are attached.

FIG. 9 is an explanatory diagram of showing a stacking state of the electric storage cells.

FIG. 10 is an explanatory diagram of showing a state in which the frame supports are attached.

FIG. 11 is an explanatory diagram of showing a state in which side members and electrode supports are attached.

FIG. 12 is an explanatory diagram of showing a state in which cable covers are attached.

FIG. 13 is an explanatory diagram of showing a state in which the rear plate and the front plate are attached.

FIG. 14A is an explanatory diagram of showing a first example of wire winding.

FIG. 14B is an explanatory diagram of showing a second example of the wire winding.

FIG. 14C is an explanatory diagram of showing a third example of the wire winding.

FIG. 15 is an explanatory diagram of showing a state in which a wire stretched via a spacer disposed adjacent to the rear plate.

### DETAILED DESCRIPTION OF THE INVENTION

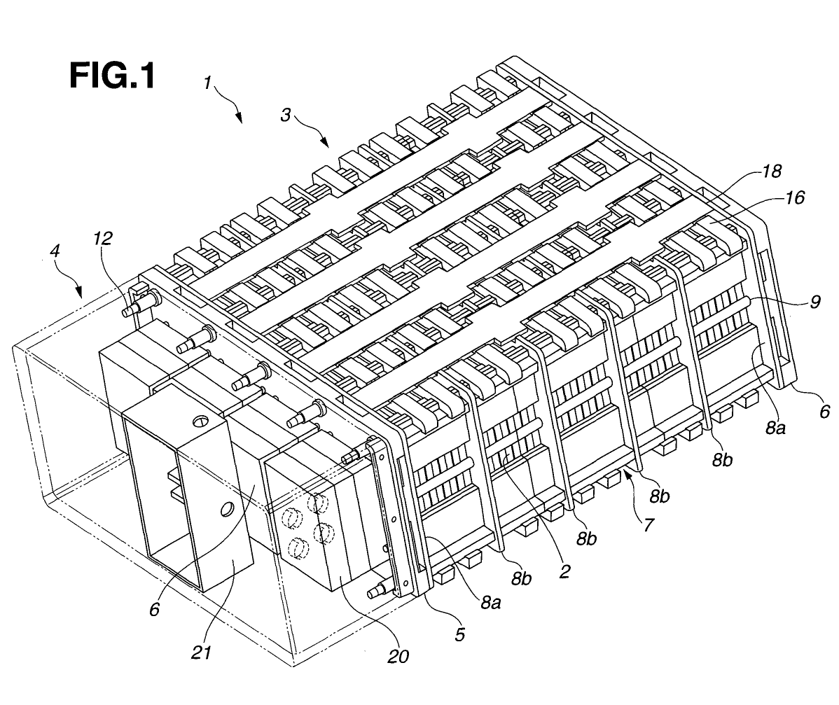

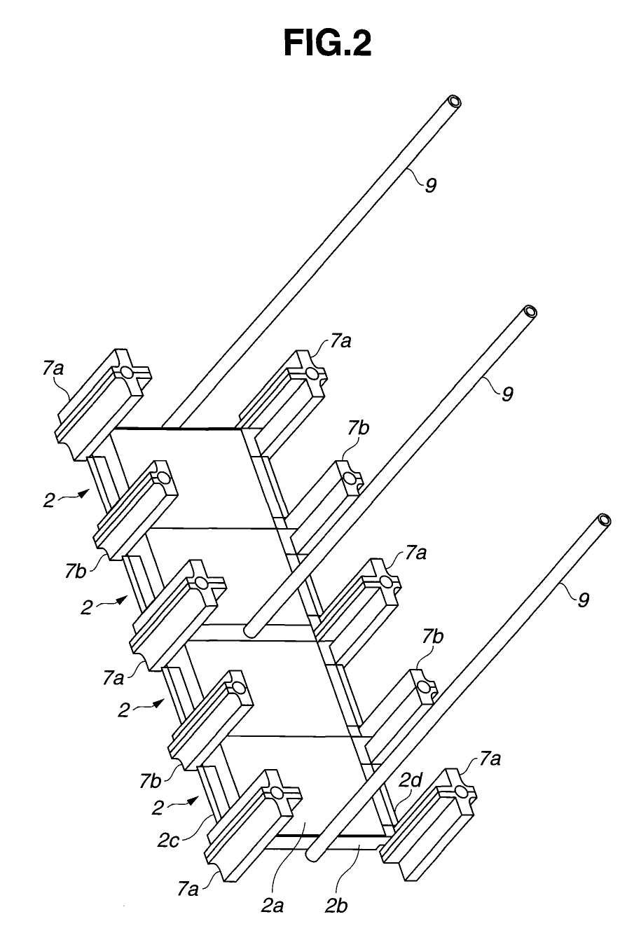

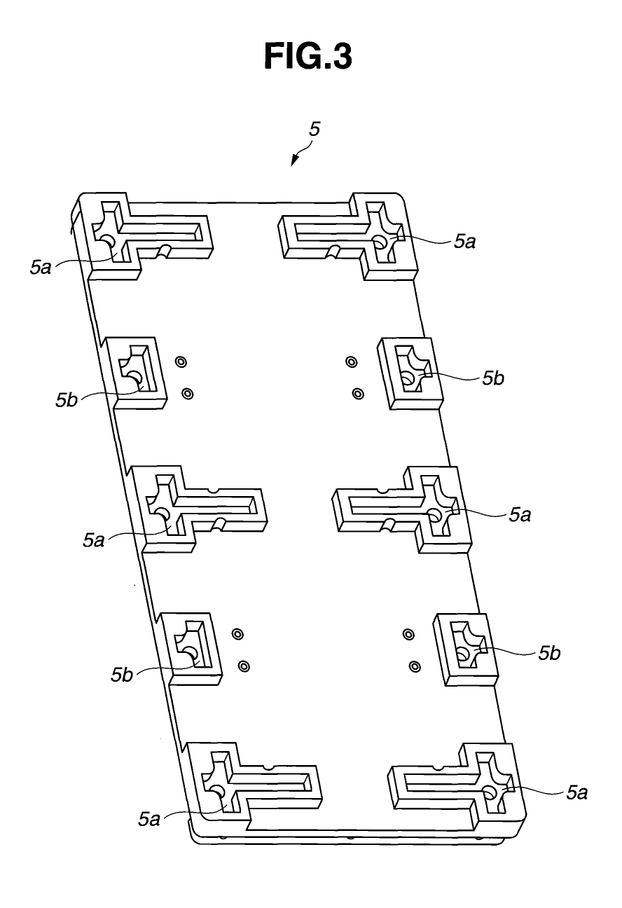

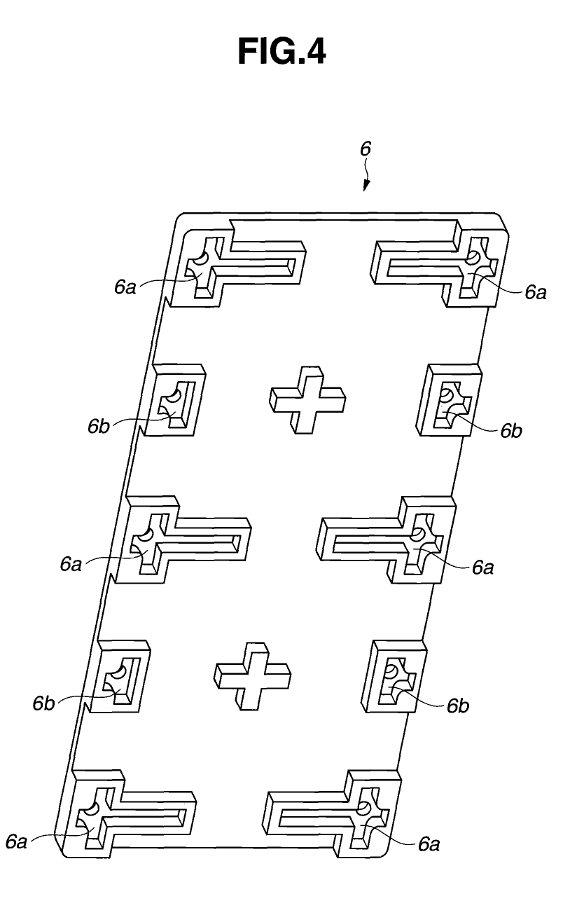

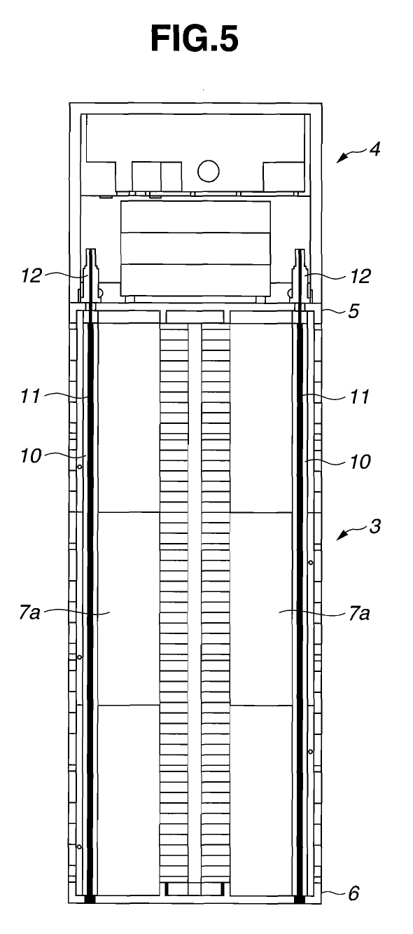

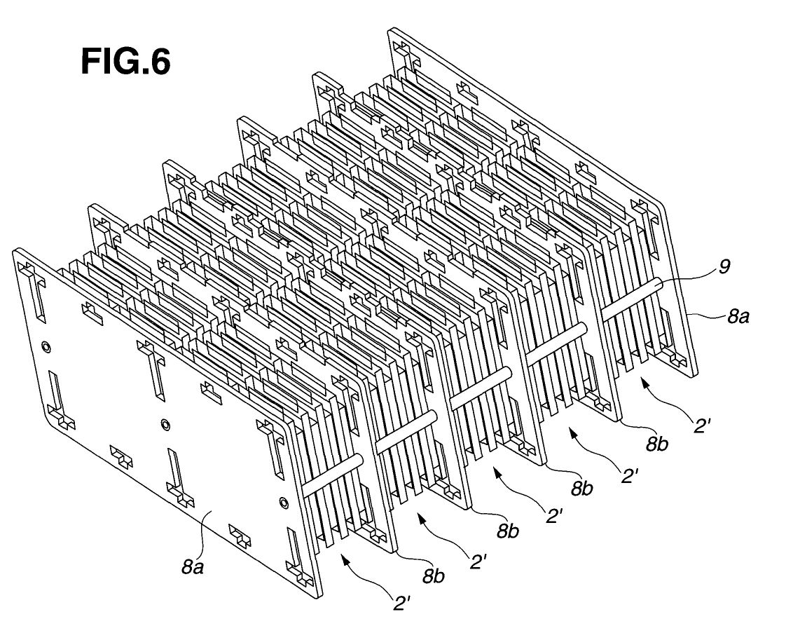

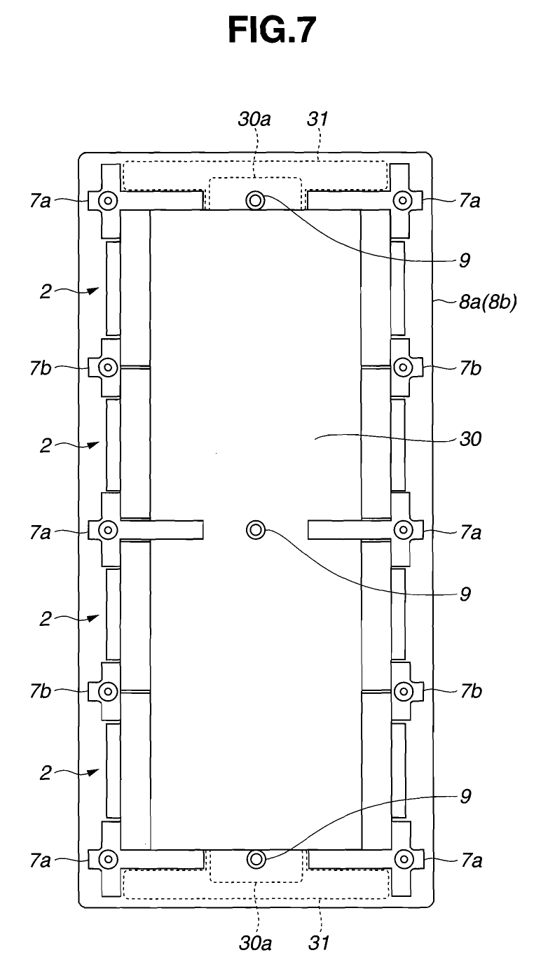

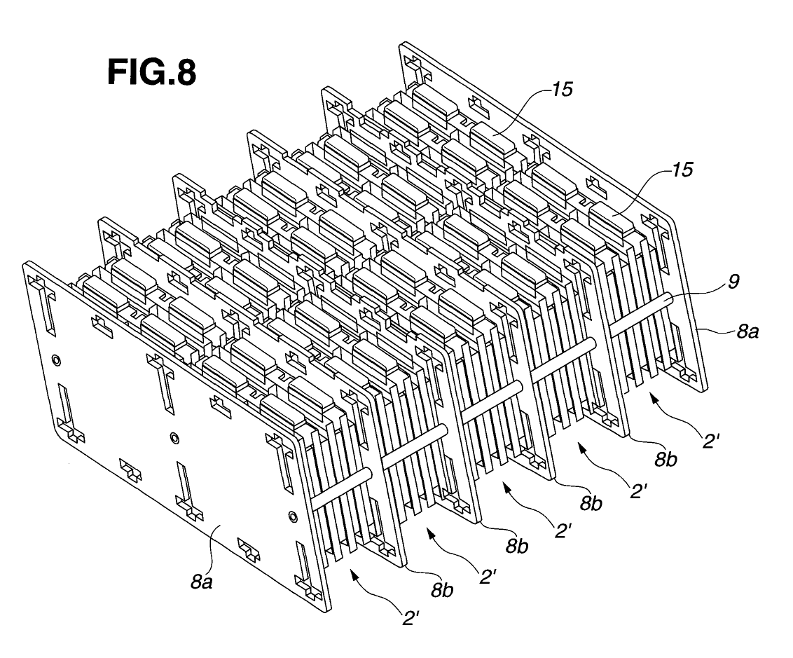

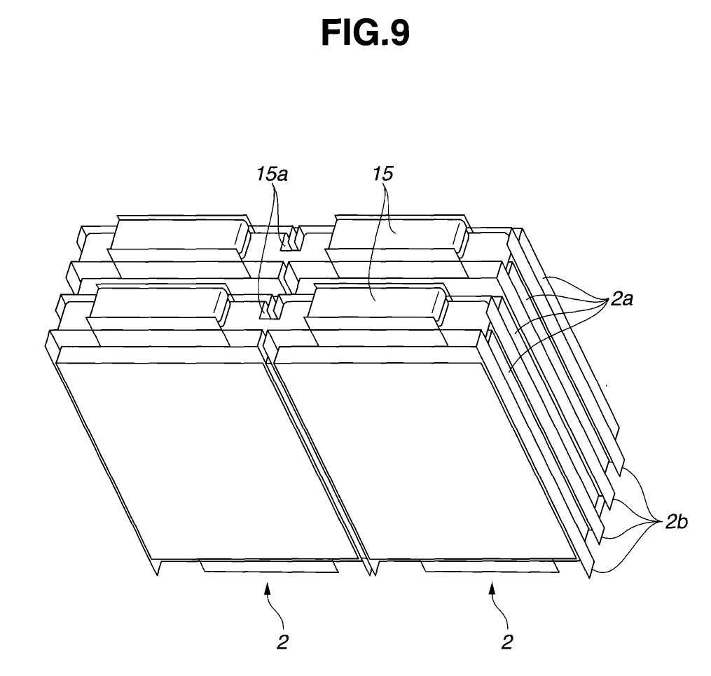

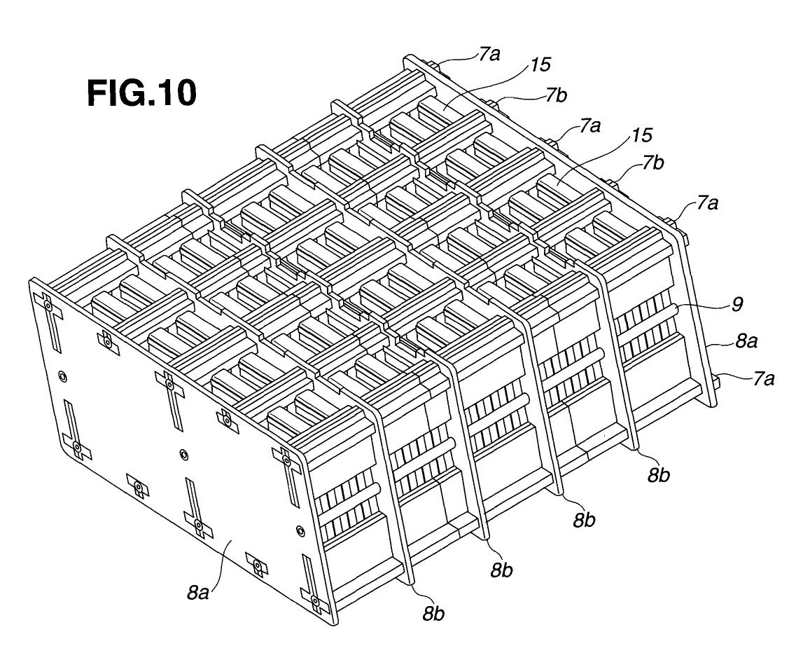

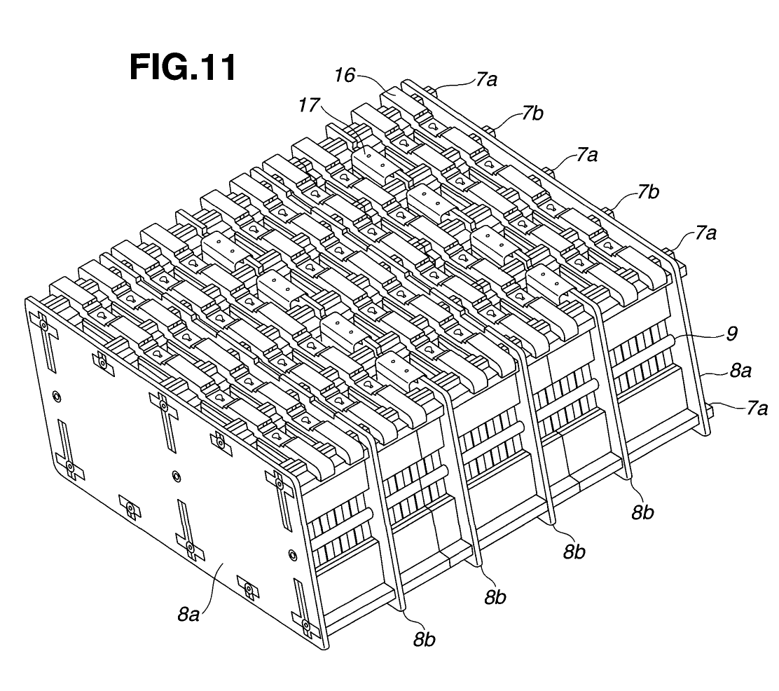

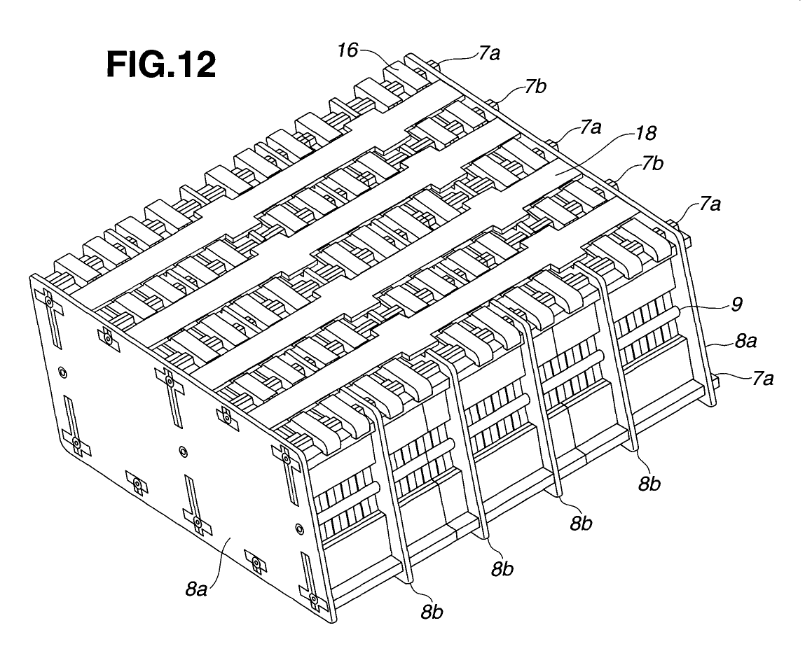

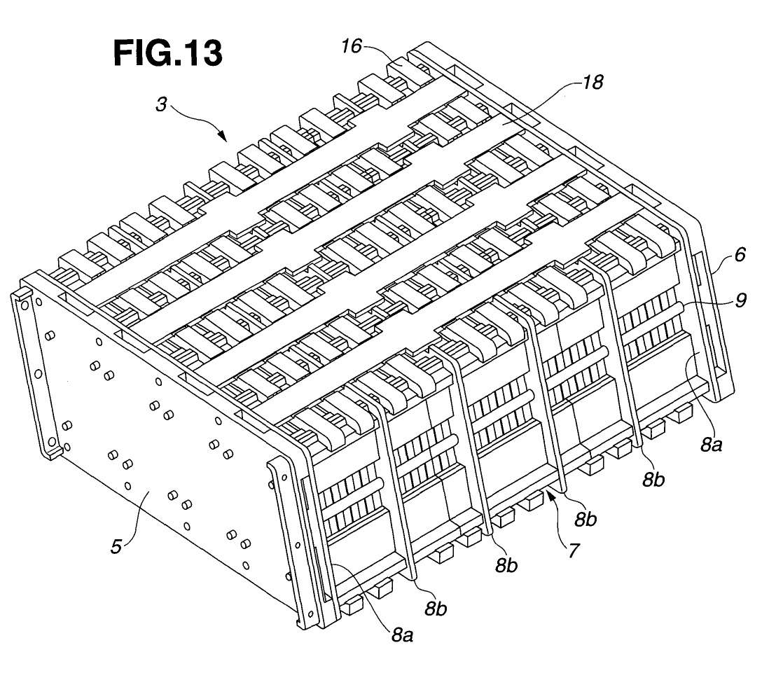

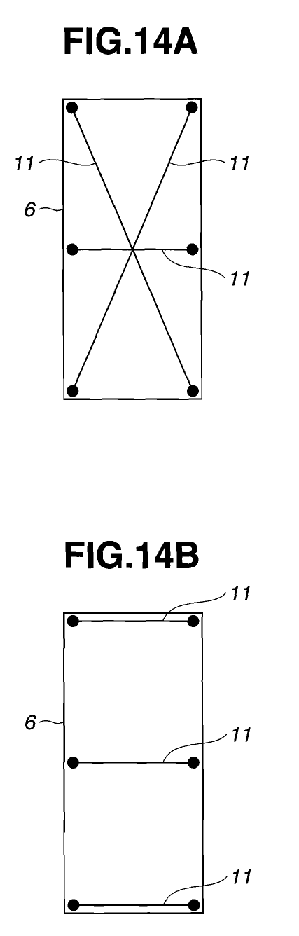

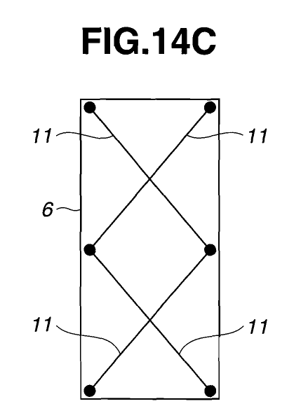

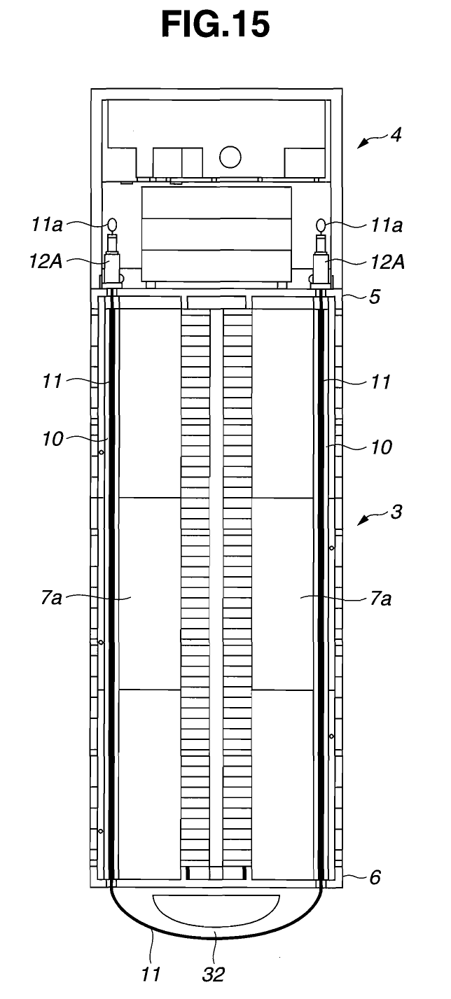

Embodiments of the present invention will now be described with reference to the drawings. FIGS. 1 to 15 are explanatory diagrams of showing an embodiment of the present invention. FIG. 1 is a general view of a power-supply unit including an electric storage package. FIG. 2 is an explanatory diagram of showing the layout of frame supports and heat-transferring pipes. FIG. 3 is an explanatory diagram of showing a front plate. FIG. 4 is an explanatory diagram of showing a rear plate. FIG. 5 is an explanatory diagram of showing a central cross section of the electric storage package in the longitudinal direction thereof. FIG. 6 is an explanatory diagram of showing a state of electric storage cells stacked via intermediate plates. FIG. 7 is an explanatory diagram of showing an example of connection between a heat-transferring sheet film and external heat-releasing members. FIG. 8 is an explanatory diagram of showing a state of the electric storage cells to which tab supports are attached. FIG. 9 is an explanatory diagram of showing a stacking state of the electric storage cells. FIG. 10 is an explanatory diagram of showing a state in which the frame supports are attached. FIG. 11 is an explanatory diagram of showing a state in which side members and electrode supports are attached. FIG. 12 is an explanatory diagram of showing a state in which cable covers are attached. FIG. 13 is an explanatory diagram of showing a state in which the rear plate and the front plate are attached. FIG. 14A is an explanatory diagram of showing a first example of wire winding. FIG. 14B is an explanatory diagram of showing a second example of the wire winding. FIG. 14C is an explanatory diagram of showing a third example of the wire winding. FIG. 15 is an explanatory diagram of showing a state in which a wire stretched via a spacer disposed adjacent to the rear plate.

In FIG. 1, a power-supply unit 1 used for, for example, electric vehicles (EVs), hybrid electric vehicles (HEVs), and the like, is an assembled battery including an electric storage package 3 in which a plurality of flat electric storage cells 2 are stacked and connected to each other (in series, in parallel, or combination of these). A joint box 4 accommodating peripherals 20 such as an equalizing circuit (voltage-balancing circuit) for equalizing voltages for each predetermined cell, a temperature-detecting circuit, an electronic controller for controlling the energy of the electric storage, relay (safety) plugs, fuses, and external supply terminals, and a relay box 21 is disposed at an end surface of the electric storage package 3.

Hereinafter, a side of the electric storage package 3 adjacent to the joint box 4 is referred to as a front side, and the other side is referred to as a rear side.

The electric storage cells 2 are flat electric storages such as lithium-ion secondary batteries and electric double-layer capacitors having substantially flat and rectangular shapes, and each of the electric storage cells 2 is formed of a lamination of internal electrodes and electrolyte layers hermetically sealed using a laminated sheet film including, for example, an aluminum-based metallic layer and a resin layer serving as an insulating coating applied on the metallic layer as typified by flat laminated lithium-ion secondary batteries.

That is, the electric storage cells 2 each include a rectangular electric storage portion 2a encompassing components for storing electricity including the lamination of the electrolyte layers and the electrodes and having a thickness slightly larger than that around the portion, a sheeted sealing portion 2b extending around the electric storage portion 2a, and metallic tabs 2c and 2d serving as positive and negative terminals, respectively, exposed from either end of the sealing portions 2b (see FIG. 2). As described below, parts of the sealing portions 2b at both sides of the tabs 2c and 2d are folded during stacking of the electric storage cells 2 such that the accommodating space for the package is reduced.

When two or more flat electric storage cells 2 having such a structure and including internal electrodes composed of active material paste applied on underlying metal foil as in lithium-ion batteries or the like are stacked, there is a possibility that the active material peels off the underlying metal foil due to vibration during use. Moreover, the temperature of the entire package can be excessively increased due to the stored heat of the stacked cells in use, and a decrease in electricity storage or degradation of power generation capacity may occur.

Therefore, the electric storage package 3 has a surface-pressurizing multilayer packaging structure in which the cells are stacked while predetermined pressures (surface pressures) are applied to the electric storage portions 2a of the cells and, at the same time, a heat-releasing multilayer packaging structure in which the heat-releasing performance of the stacked cells is improved such that the degradation and the deterioration of the characteristics due to vibration or heat generated during use are prevented and such that the characteristics of the cells are stabilized. With this, the performance of the entire package can be improved.

More specifically, the electric storage package 3 has a frame formed using a tabular front plate 5 serving as a rectangular frame surface adjacent to the front side where the peripherals such as the equalizing circuit are disposed, a tabular rear plate 6 serving as a rectangular frame surface disposed adjacent to the rear side so as to face the front plate 5 having a predetermined distance from the front plate 5, frame supports 7 serving as a framework formed of a plurality of columnar members disposed between the front plate 5 and the rear plate 6 so as to align the electric storage cells 2 and to accommodate the lamination of the electric storage cells 2, and intermediate plates 8a and 8b serving as thick boards disposed between the front plate 5 and the rear plate 6. The front plate 5, the rear plate 6, and the frame supports 7 are composed of resin or the like so as to ensure insulation and weight reduction.

The electric storage cells 2 stacked between the front plate 5 and the rear plate 6 are directly retained between two flat rectangular intermediate plates 8a that are in contact with the front plate 5 and the rear plate 6. Heat-transferring sheet films 30 for transferring and diffusing heat are disposed between layers of the electric storage cells 2 and are stuck to the stacking surfaces (electric storage portions 2a ) of the cells (see FIG. 7). The intermediate plates 8b are disposed on the stacking surfaces of modules each including a predetermined number of cells (five cells in this embodiment).

The intermediate plates 8a and 8b are basically the same components except that the external shapes thereof partly differ from each other. Each of the intermediate plates 8a and 8b is formed of a thick rectangular board having through-holes into which the frame supports 7 are fitted, and is engaged with the frame supports 7 so as to be movable in the longitudinal direction of the frame supports 7. These intermediate plates 8a and 8b are tabular members that are in contact with the stacking surfaces of the electric storage cells 2 so as to retain the electric storage cells 2 therebetween and to transfer and release the heat generated at the electric storage cells 2. The intermediate plates 8a and 8b lend themselves to improving the heat-releasing performance of the electric storage cells 2 and to equalizing and smoothing the surface pressures on the stacking surfaces, and at the same time, fulfill a role in reinforcing the rigidity of the entire package. These functions can be achieved by forming the intermediate plates 8a and 8b using a lightweight material having high rigidity, excellent thermal absorptivity, and excellent thermal radiation, for example, a composite of a carbon-based material and an aluminum-based material.

Reference numbers 12, 16, and 18 denote bases for fixing wires 11 (described below; see FIG. 5), side members extended over the plurality of frame supports 7, and cable covers that cover wiring lines for connecting the cells, respectively. The intermediate plates 8a and 8b differ from each other in that recessed portions to which electrode supports 17 (see FIG. 11) to be covered with the cable covers 18 are attached are formed in the outer edges of the long sides of the intermediate plates 8b and no recessed portions to which the electrode supports 17 are attached are formed in the intermediate plates 8a.

Moreover, hollow heat-transferring pipes 9 serving as heat-transferring members pass through the intermediate plates 8a and 8b and the heat-transferring sheet films 30 at three positions, i.e., both ends adjacent to the narrow sides and central portions, of the intermediate plates 8a and 8b. The heat-transferring pipes 9 fulfill a role as heat pipes that three-dimensionally transfer the heat of the cells to the intermediate plates 8a and 8b. It is preferable that heat-radiating fins are provided for two of the heat-transferring pipes 9 located at both ends of the intermediate plates 8a and 8b and exposed to the outside so as to promote heat radiation using air cooling. Furthermore, the heat-transferring pipes 9 can be used as water-cooling pipes by running cooling water therethrough. Conversely, when the temperature is low, the passage of warm water or the like inside the heat-transferring pipes 9 can effectively warm the cells up so as to stabilize the characteristics of the cells.

FIG. 2 illustrates the layout of the frame supports 7 and the heat-transferring pipes 9. In this embodiment, the frame supports 7 include frame supports 7a each having a substantially cross-shaped cross section and a through-hole passing therethrough in the longitudinal direction thereof, and frame supports 7b each having a substantially T-shaped cross section and a through-hole passing therethrough in the longitudinal direction thereof. Six frame supports 7a having the substantially cross-shaped cross sections are disposed at three positions, i.e., both ends and a central portion, on each of the two long sides of the front plate 5 or the rear plate 6 in two groups of three so as to be symmetrical to each other, and four frame supports 7b having the substantially T-shaped cross sections are disposed at intermediate positions of the three frame supports 7a on each of the two long sides of the front plate 5 or the rear plate 6 in two groups of two so as to be symmetrical to each other.

In this embodiment, the electric storage cells 2 are arranged using the frame supports 7a and 7b of the two different types. However, the frame supports can be of one type. Moreover, in this embodiment, the plurality of frame supports 7a and 7b are connected to each other so as to extend to a predetermined length, and hollow pipes 10 (see FIG. 5) for connection and reinforcement are fitted into the through-holes of the corresponding frame supports such that the frame supports are connected in the longitudinal direction thereof. With this, the length of the frame supports can be adjusted according to the height of the electric storage cells 2 to be stacked.

Furthermore, the frame supports 7a and 7b can be integrated with the rear plate 6 so as to form a frame having a shape similar to a rack for stocking newspaper and the like in advance. When such a rack-shaped frame is used, the front plate 5 is attached to the open end after the electric storage cells 2 are stacked in the rack-shaped frame. The package can form the surface-pressurizing multilayer packaging structure and the heat-releasing multilayer packaging structure using basically the same components also in this case.

Four electric storage cells 2 to be stacked are arranged in a two-dimensional manner in two groups of two such that the tabs 2c and 2d are disposed between the corresponding frame supports 7a and 7b and such that a gap formed by the frame supports 7a located at the central portions of the long sides of the front plate 5 or rear plate 6 is disposed between the two groups so as to form one layer. The intermediate plates 8b are disposed behind every five layers so as to retain the electric storage cells 2 therebetween. Two heat-transferring pipes 9 are disposed at both sides of the lamination of the electric storage cells 2, and furthermore, another heat-transferring pipe 9 is disposed at the gap between the electric storage cells 2 sectioned by the frame supports 7a located at the central portions of the long sides of the front plate 5 or the rear plate 6.

The central heat-transferring pipe 9 passes through the heat-transferring sheet films 30 stuck to the stacking surfaces of the four electric storage cells 2 in each layer. These heat-transferring pipes 9 at the center and both sides of the stacking surfaces of the electric storage cells 2 can three-dimensionally transfer the heat of the stacking surfaces of the cells to the intermediate plates 8a and 8b such that the heat of the entire package is balanced and is efficiently released.

Head portions of the frame supports 7a in the substantially cross-shaped cross section and projecting portions of the frame supports 7b in the substantially T-shaped cross section have the same projecting shapes. The frame supports 7a and 7b are disposed such that these projecting portions face outward, and the side members 16 are engaged with and extended over the projecting portions of the frame supports 7a and 7b after tab supports 15 (described below; see FIG. 8) are attached to the tabs 2c and 2d of the electric storage cells 2. With this, rigidity in the torsional direction can be ensured.

As shown in FIG. 3, in accordance with the above-described frame supports 7a and 7b, substantially cross-shaped recessed portions 5a into which ends of the frame supports 7a are fitted are formed at both ends and central portions of the long sides of the front plate 5 on a surface of the front plate 5 adjacent to the stacking surfaces of the cells, and substantially T-shaped recessed portions 5b into which ends of the frame supports 7b are fitted are formed at intermediate positions between the recessed portions 5a at both ends and at the central portions of the long sides of the front plate 5. Similarly, as shown in FIG. 4, substantially cross-shaped recessed portions 6a into which the other ends of the frame supports 7a are fitted are formed at both ends and central portions of the long sides of the rear plate 6 on a surface of the rear plate 6 adjacent to the stacking surfaces of the cells, and substantially T-shaped recessed portions 6b into which the other ends of the frame supports 7b are fitted are formed at intermediate positions between the recessed portions 6a at both ends and at the central portions of the long sides of the rear plate 6.

The recessed portions 5a and 5b on the front plate 5 and the recessed portions 6a and 6b on the rear plate 6 each have a through-hole communicating with the hollow pipes 10 inside the frame supports 7a and 7b . As shown in FIG. 5, ends of the wires 11 such as stranded steel wires are engaged with the rear plate 6, and the other ends of the wires 11 are fixed to the bases 12 extending from the front plate 5 using caulking or the like such that the wires 11 extend through the hollow pipes 10 with predetermined tensions. The tensions of the wires 11 act so as to press the stacking surfaces of the cells with predetermined surface pressures using the intermediate plates 8a and 8b via the front plate 5 and the rear plate 6. That is, the wires 11 and the bases 12 are used as pressurizing members for applying predetermined pressures to the stacking surfaces of the electric storage cells 2 so as to retain the electric storage cells 2 by applying predetermined loads to the intermediate plates 8a and 8b.

Next, assembling procedure of the electric storage package 3 having the above-described structure will be described. The assembling procedure described below is a brief outline, and is not limited to that described below. The order of the processes can be changed in practical assembling work.

First, four electric storage cells 2 are arranged on the intermediate plate 8a in a two-dimensional manner such that the tabs 2c and 2d are exposed outward from the long sides of the intermediate plate 8a so as to form one layer. The heat-transferring sheet films 30 are disposed on each layer. As shown in FIG. 6, five layers of the electric storage cells 2 form an electric storage module 2′, and the intermediate plates 8b are disposed on each of the electric storage modules 2′. At the same time, the heat-transferring pipes 9 are disposed at both sides and at the center of the intermediate plates 8a and 8b.

As shown in FIG. 7, the heat-transferring sheet films 30 are substantially rectangular sheets disposed between the heat-transferring pipes 9 at both ends of the heat-transferring sheet films 30. It is preferable that the heat-transferring sheet films 30 include tongue-shaped tabs 30a indicated by broken lines in the drawing exposed outward from the stacking surfaces of the electric storage cells 2 at positions adjacent to the narrow sides of the intermediate plates 8a and 8b, and the heat-transferring pipes 9 at both ends of the heat-transferring sheet films 30 pass through the tabs. Due to the tabs 30a exposed outward from the stacking surfaces of the cells, the heat of the cells in each layer can be effectively released in the longitudinal direction (direction along which the cells are arranged). In FIG. 7, the frame supports 7a and 7b are disposed on the intermediate plate 8a (8b ).

Moreover, in order to effectively release the heat of the cells in each layer from the tabs 30a of the heat-transferring sheet films 30, it is preferable that external heat-releasing members 31 indicated by broken lines shown in FIG. 7 are disposed between the frame supports 7a adjacent to the narrow sides of the intermediate plates 8a and 8b, and that the heat-transferring pipes 9 at both ends of the heat-transferring sheet films 30 pass through the external heat-releasing members. These external heat-releasing members 31 are preferably connected to the tabs 30a of the heat-transferring sheet films 30 with surface-to-surface contact. When the external heat-releasing members 31 and the tabs 30a of the heat-transferring sheet films 30 are connected with surface-to-surface contact, silicon grease, for example, can be applied so as to increase a degree of adhesion and to improve efficiency of heat transfer.

The external heat-releasing members 31 can be composed of a lightweight material having an excellent thermal conductivity such as aluminum, and can be formed of tabular members corresponding to the heat-transferring sheet films 30 on each layer, or formed of members having fins outside and slit-shaped contact portions inside, the tabs 30a of the heat-transferring sheet films 30 being fitted into the contact portions. With this, the heat generated at the cells in each layer can be effectively transferred in the stacking direction of the cells and in the arranging direction of the cells such that the heat of the entire package can be balanced, resulting in an improvement in performance.

Next, after a lamination of the electric storage modules 2′ is formed using the intermediate plates 8a and 8b and the heat-transferring pipes 9, the slender tab supports 15 are attached to the tabs 2c and 2d of the electric storage cells 2 in every layer as shown in FIG. 8. These tab supports 15 prevent short-circuits between the terminals, and at the same time, reinforce the terminals. As shown in FIG. 9, each of the tab supports 15 is attached to two of the electric storage cells 2 in one layer, and includes two projecting portions for supporting the tabs 2c and 2d by pinching and a slit-shaped opening 15a located between the two projecting portions for receiving the sealing portions 2b of two adjacent electric storage cells 2 folded in the stacking direction.

After the tab supports 15 are attached to the electric storage cells 2 in all the layers, the frame supports 7a and 7b are fitted into the intermediate plates 8a and 8b as shown in FIG. 10. Since the tab supports 15 are formed such that the projecting portions for pinching and supporting the tabs 2c and 2d are fitted into spaces between the frame supports 7a and 7b, the tab supports 15 are supported and fixed by the frame supports 7a and 7b.

Furthermore, as shown in FIG. 11, the side members 16 are attached so as to extend in a transverse direction of the frame supports 7a and 7b (direction substantially orthogonal to the stacking direction of the electric storage cells 2). These side members 16 are attached so as to cover the tab supports 15 in each layer, and are engaged with the projecting portions, which protrudes outward, of the frame supports 7a having the substantially cross-shaped cross section and the projecting portions, which protrudes outward, of the frame supports 7b having the substantially T-shaped cross section. With this, rigidity in the torsional direction can be improved.

Moreover, the electrode supports 17 having a substantially U-shaped cross section serving as relay points of wiring for electrically connecting the cells are engaged with recessed portions formed at predetermined positions in some of the intermediate plates 8b among the intermediate plates 8b disposed behind every five layers of the cells, the recessed portions being formed at intermediate positions between the portions into which the frame supports 7a and 7b are fitted. In FIG. 11, four electrode supports 17 are attached to each of the intermediate plates 8b located behind the fifth and fifteenth layers from the rear side.

Subsequently, after the strip-shaped cable covers 18 are attached in the stacking direction so as to cover the electrode supports 17 as shown in FIG. 12, the front plate 5 and the rear plate 6 are attached to the intermediate plates 8a at both ends of the lamination of the electric storage cells 2 as shown in FIG. 13. In this manner, the lamination of the electric storage cells 2 is packaged. As described with reference to FIG. 5, the bases 12 are attached to the front plate 5 of this package, and the wires 11 fitted into the frame supports 7a and 7b are pulled at predetermined loads using jigs or the like (not shown) and fixed to the bases 12. With this, the entire package is fixed while predetermined surface pressures are applied to the stacking surfaces of the cells.

Since ten frame supports 7a and 7b in total are used in this embodiment, ten wires 11 extending in the stacking direction of the electric storage cells 2 are used. When the size of a stacking surface of one electric storage cell 2 is, for example, 11×8 cm and a load of 10 kg is applied to one wire 11, a load of 100 kg can be applied to a stacking surface of four electric storage cells 2 arranged in a two-dimensional manner. Therefore, a surface pressure of approximately 100×10³/(11×8×4)=284 g/cm² can be applied to one electric storage cell 2.

In this case, one wire 11 can be fitted into at least two frame supports and wound onto either or both of the front plate 5 and the rear plate 6 instead of using one wire 11 for each of the frame supports 7a and 7b and fixing ends of the wires 11 at the front plate 5 and the rear plate 6.

For example, when the wires 11 are wound onto the rear plate 6, two wires 11 can be wound onto the rear plate 6 so as to diagonally intersect each other and another wire 11 can be wound so as to be parallel to the narrow sides of the rear plate 6 as shown in FIG. 14A, or the wires 11 can be stretched so as to be parallel to the narrow sides of the rear plate 6 as shown in FIG. 14B. Moreover, as shown in FIG. 14C, the wires 11 can be stretched so as to successively intersect each other on the rear plate 6. This winding of the wires 11 can apply uniform surface pressures to the stacking surfaces of the cells.

When the wires 11 are wound as described above, it is preferable that a spacer 32, having a curved-surface portion onto which the wires 11 are wound and a flat-surface portion for uniformly pressing the intermediate plates 8a via the rear plate 6 (or the front plate 5 in the case of winding of the wires 11 onto the front plate 5) using tension of the wires 11 wound onto the curved-surface portion, is disposed on the rear plate 6 (or the front plate 5) as shown in FIG. 15. The spacer 32 can be integrated with the rear plate 6 (or the front plate 5). Due to the arc winding route of the wires 11, the loads can be uniformly and efficiently transmitted from the wires 11 to the stacking surfaces of the cells.

Moreover, as shown in FIG. 15, looped hooks 11a can be formed on the ends of the wires 11 adjacent to the front plate 5. The wires 11 can be pulled using jigs or the like (not shown) engaged with the hooks 11a such that loads are applied to the stacking surfaces of the cells. Furthermore, bases 12A including a mechanism for stretching the wires (for example, mechanism using cams or the like), the mechanism allowing the movement of the wires 11 only in a direction to be spaced from the front plate 5 and capable of fixing the wires 11 at any positions, can be disposed on the front plate 5 so as to improve the workability.

Through-bolts can be used instead of the wires 11 for applying surface pressures to the stacking surfaces of the electric storage cells 2. When the though-bolts are used, female screw threads are cut in the bases 12 such that the surface pressures applied to the cells are adjusted by adjusting the fastening power via the bases 12. Moreover, insulator can be employed instead of the wires.

As described above, in this embodiment, the heat generated at the electric storage cells 2 can be released using the intermediate plates 8a and 8b, and at the same time, uniform surface pressures can be applied to the cells via the intermediate plates 8a and 8b using the wires 11 provided for the frame supports 7a and 7b that support the intermediate plates 8a and 8b. With this, the surface-pressurizing multilayer packaging structure and the heat-releasing multilayer packaging structure can be realized at the same time. Thus, the characteristics of the cells are stabilized, and the performance of the entire package can be improved.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A packaging structure of electric storage cells including a plurality of flat electric storage cells stacked and packaged, comprising:
tabular members in contacting stacking surfaces of the electric storage cells so as to retain the electric storage cells between the tabular members and to transfer and release heat generated at the electric storage cells;
columnar members that form a framework for accommodating a lamination of the electric storage cells and are engaged with the tabular members such that the tabular members are movable in a stacking direction of the electric storage cells; and
pressurizing members that are provided for the columnar members and apply a predetermined pressure to the stacking surfaces of the electric storage cells so as to retain the electric storage cells by applying a predetermined load to the tabular members,
wherein sheet films for transferring heat generated at electric storage portions of the electric storage cells are disposed on the stacking surfaces of the electric storage cells in each layer so as to be stuck to the electric storage portions.

2. The packaging structure of electric storage cells according to claim 1, wherein the tabular members are disposed at intervals of a predetermined number of layers in the lamination stacked the electric storage cells.

3. The packaging structure of electric storage cells according to claim 1, wherein a heat-transferring member is provided for the tabular members so as to three-dimensionally transfer heat in the stacking direction of the electric storage cells, the heat being transferred from the electric storage cells to the tabular members.

4. The packaging structure of electric storage cells according to claim 3, wherein the heat-transferring member is a hollow pipe.

5. The packaging structure of electric storage cells according to claim 1, wherein the pressurizing members are wires extending through the columnar members with a predetermined tension.

6. The packaging structure of electric storage cells according to claim 5, further comprising a spacer including a curved-surface portion onto which the wires extending from the columnar members are wound and a pushing portion for uniformly pressing the tabular members using the tension of the wires wound onto the curved-surface portion.

7. The packaging structure of electric storage cells according to claim 1, wherein the pressurizing members are screws that engage the columnar members and the tabular members.

8. The packaging structure of electric storage cells according to claim 1, wherein the tabular members are composed of a composite of a carbon-based material and an aluminum-based material.
